(19) United States
(12) Patent Application Publication
(10) Pub. No.: US 2023/0033796 A1
(43) Pub. Date: Feb. 2, 2023

(54) SYSTEMS AND METHODS FOR DETERMINING EXTENDED WARRANTY PRICING BASED ON MACHINE ACTIVITY

(71) Applicant: Caterpillar Inc., Peoria, IL (US)

(72) Inventors: Prashant Rai, Champaign, IL (US); Kyle J. Cline, Savoy, IL (US)

(21) Appl. No.: 17/389,043

(22) Filed: Jul. 29, 2021

(51) Int. Cl. G06Q 30/02; G06Q 30/00; G06N 3/08

(52) U.S. Cl. CPC G06Q 30/0283; G06Q 30/012; G06N 3/08

(57) ABSTRACT

A method for estimating warranty costs for an individual machine can include training a warranty cost model. The method can also include receiving telematics data from a plurality of sensors on an individual machine and determining one or more activity types for the individual machine based on the associated telematics data. A mean activity time can be calculated for each activity type. The mean activity time for each activity type can be fed into the trained warranty cost model to provide a predicted warranty cost for the individual machine and a corresponding probability of the predicted warranty cost from the trained warranty cost model.

### TECHNICAL FIELD

This patent application is directed to extended protection plans, and more specifically, to determining extended warranty pricing based on individual machine activity.

### BACKGROUND

Extended warranties or extended protection plans are often priced as one-size-fits-all plans for each machine model. Typically these plans are priced conservatively to ensure that the warranty provider does not lose money. Accordingly, these plans can be perceived as overpriced in some cases. Accordingly, consumers do not always purchase an extended warranty plan when it would benefit them to do so.

Efforts have been made to manage work machine assets based on data acquisition. For example, U.S. Patent Application Publication No. 2007/0078791 to Vyas et al., (hereinafter “Vyas”) describes an asset management system including data collection devices configured to monitor operating conditions of a work machine. The collected data is used to predict a cost to maintain the work machine in the future. The system compares the predicted cost to maintain the work machine to a depreciated value of the machine to determine a time for replacement of the work machine. The time to replace the work machine is determined to be where the cost to maintain the machine over time crosses the depreciated value of the machine over time. The collected data is used to increase or decrease the cost to maintain the machine based on how much and hard the data suggests that the machine is being used.

Vyas bases the increase or decrease on predicted cost to maintain the work machine based on how much and how hard the machine is used. However, Vyas does not tailor these adjustments based on the type of activities the machine is performing, which can have a significant impact on the cost to maintain a work machine. Furthermore, Vyas is not directed to extended warranty pricing.

Thus, there are still opportunities to improve extended warranty pricing. The example systems and methods described herein are directed toward overcoming one or more of the deficiencies described above and/or other problems with the prior art.

### SUMMARY

In some embodiments, a method for estimating warranty costs for an individual machine can include training a warranty cost model. The method can also include receiving telematics data from a plurality of sensors on an individual machine and determining one or more activity types for the individual machine based on the associated telematics data. A mean activity time can be calculated for each activity type based on the determined activity types. The mean activity time for each activity type can be fed into the trained warranty cost model to provide a predicted warranty cost for the individual machine and a corresponding probability of the predicted warranty cost from the trained warranty cost model.

According to some aspects, training the warranty cost model includes collecting warranty cost data for a plurality of machines over a warranty time period, and collecting activity data for a plurality of activity types over the warranty time period for each of the plurality of machines. Training the model can also include calculating a mean activity time for each activity type for each of the plurality of machines based on the collected activity data, and training the warranty cost model using the mean activity time for each activity type and the corresponding warranty cost data for each of the plurality of machines. In some aspects, collecting the activity data comprises receiving telematics data from a plurality of sensors on each of the plurality of machines and determining one or more activity types for each machine based on the associated telematics data. In some aspects, the method can further comprise calculating an warranty price based on the predicted warranty cost and the corresponding probability. In certain aspects, the warranty price is for an extended warranty. According to certain aspects, the warranty cost model comprises a neural network.

In some embodiments, a system for estimating warranty costs for an individual machine can include one or more processors and one or more memory devices having instructions stored thereon. When executed, the instructions cause the processors to train a warranty cost model. The instructions can also cause the processors to receive telematics data from a plurality of sensors on an individual machine and determine one or more activity types for the individual machine based on the associated telematics data. A mean activity time can be calculated for each activity type. The mean activity time for each activity type can be fed into the trained warranty cost model to provide a predicted warranty cost for the individual machine and a corresponding probability of the predicted warranty cost from the trained warranty cost model.

In some aspects, the system can further comprise the plurality of sensors on the individual machine. According to certain aspects, the telematics data from the plurality of sensors is received via a satellite network.

In some embodiments, one or more non-transitory computer-readable media storing computer-executable instructions that, when executed by one or more processors, cause the one or more processors to perform operations. The operations can include training a warranty cost model. The operations can also include receiving telematics data from a plurality of sensors on an individual machine and determining one or more activity types for the individual machine based on the associated telematics data. A mean activity time can be calculated for each activity type. The mean activity time for each activity type can be fed into the trained warranty cost model to provide a predicted warranty cost for the individual machine and a corresponding probability of the predicted warranty cost from the trained warranty cost model.

### BRIEF DESCRIPTION OF THE DRAWINGS

The systems and methods described herein may be better understood by referring to the following Detailed Description in conjunction with the accompanying drawings, in which like reference numerals indicate identical or functionally similar elements:

FIG. 1 is a diagram illustrating an overview of an environment in which some implementations can operate according to embodiments of the disclosed technology;

FIG. 2 is a block diagram illustrating an overview of an extended warranty pricing system according to some embodiments of the disclosed technology;

FIG. 3 is a diagram illustrating representative machine activity;

FIG. 4 is a flow diagram showing a method for estimating warranty costs and pricing for an individual machine according to some embodiments of the disclosed technology;

FIG. 5 is a flow diagram showing a method for training a warranty cost model according to some embodiments of the disclosed technology;

FIG. 6 is a block diagram illustrating an overview of devices on which some implementations can operate;

FIG. 7 is a block diagram illustrating an overview of an environment in which some implementations can operate; and

FIG. 8 is a block diagram illustrating components which, in some implementations, can be used in a system employing the disclosed technology.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. On the contrary, the embodiments are intended to cover all suitable modifications, combinations, equivalents, and alternatives falling within the scope of this disclosure.

### DETAILED DESCRIPTION

Various examples of the systems and methods introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

Disclosed are methods and systems for machine learning based analysis of historical usage of machines for different applications to determine the probability of a profitable extended warranty plan pricing by estimating future warranty claims in a given time window. Therefore, the disclosed technology can offer an adjusted price of extended warranty plans that are potentially lower than a one-size-fits-all offer.

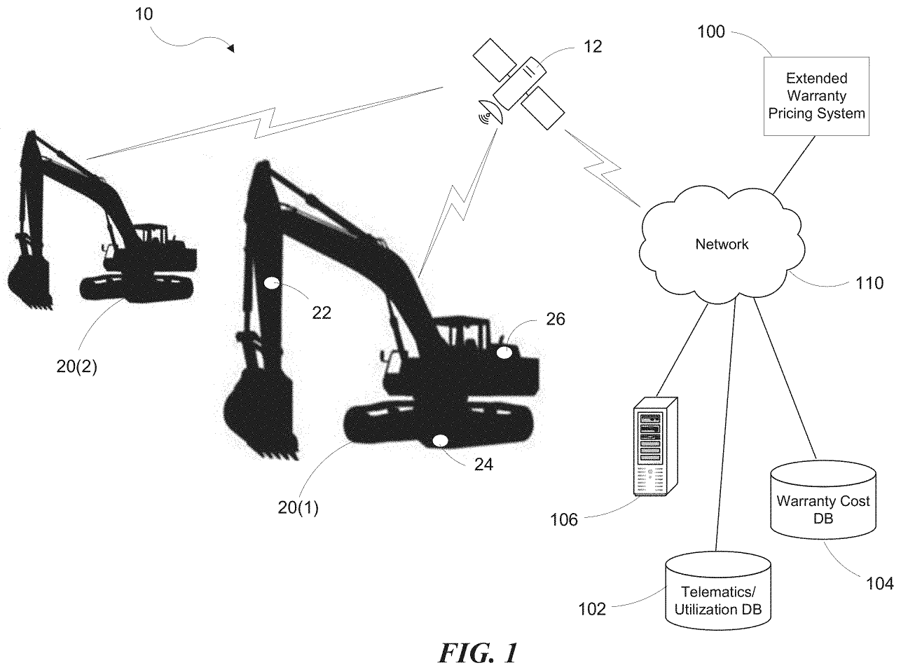

FIG. 1 illustrates an environment 10 in which some implementations of the extended warranty pricing system 100 can operate according to embodiments of the disclosed technology. The system environment 10 can include multiple machines, such as excavators 20(1) and 20(2), a satellite 12, telematics/utilization database 102, a warranty cost database 104, a telematics processing system 106, and a network 110. The extended warranty pricing system 100 can be connected to the telematics/utilization database 102, the warranty cost database 104, and the telematics processing system 106 via network 110. The telematics/utilization database 102 and the telematics processing system 106 can receive telematics data from the excavators 20(1) and 20(2) via satellite 12. The telematics data can include sensor data from the excavators, such as from a pressure sensor 22, a vibration sensor 24, and a temperature sensor 26, to name a few.

In some embodiments, the telematics processing system 106 determines a machine utilization pattern for the machines based on the telematics data. For example, a machine learning model (such as a neural network) can be applied to estimate each machine's utilization pattern based on telematics data (i.e., telemetry data). As an example, an excavator can have a use pattern of activities including 50% mass excavation, 20% grading, and 30% tracking (i.e., traveling from place to place).

In some embodiments, a utilization model can use mathematical models that classify equipment activity or application frequencies, which can include regression, support vector machines, and neural nets, depending on the level of detail and complexity required. These models may differentiate between, for example, mass excavation, dirt moving, trenching, scraping, grading, loading, tracking, or idle time. Models may supplement standard telematics data with additional sensors to measure the intensity of use. The resulting machine utilization patterns, or activity data, can be provided to the extended warranty pricing system 100, along with corresponding warranty cost data, to calculate an extended warranty price based on a predicted future warranty cost for the individual machine and a corresponding probability.

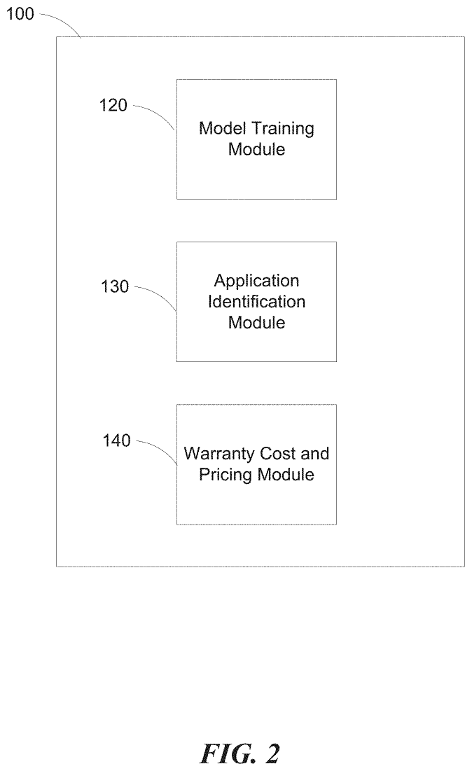

As shown in FIG. 2, the extended warranty pricing system 100 can comprise a model training module 120, an application identification module 130, and a warranty cost and pricing module 140. In some embodiments, the model training module 120 can be configured to collect warranty cost data from the warranty cost database 104 for a plurality of machines. Module 120 can also collect activity data for a plurality of activity types for each of the plurality of machines and calculate (or receive from module 130) a mean activity time for each activity type for each of the plurality of machines based on the collected activity data. The module 120 then trains a warranty cost model, such as a neural network, using the mean activity time for each activity type and the corresponding warranty cost data for each of the plurality of machines.

In some embodiments, the application identification module 130 is configured to receive machine activity data from the telematics processing system 106 for a plurality of machines with known warranty costs as training data. Module 130 can also receive machine activity data for an individual machine to be used by the warranty cost and pricing module 140 to determine extended warranty pricing for that machine. The application identification module 130 is configured to calculate a mean activity time for each activity type for each of the plurality of machines used for training as well as the individual machine.

In some embodiments, the warranty cost and pricing module 140 is configured to feed the mean activity time for each activity type of the individual machine into the trained warranty cost model. The module 140 also receives a predicted warranty cost for the individual machine and a corresponding probability. The module is also configured to calculate an extended warranty price for the individual machine based on the predicted warranty cost and the corresponding probability. The extended warranty price can be calculated by dividing the predicted warranty cost by the corresponding probability. In some embodiments, an additional profit margin can be added to the result. In other embodiments, the predicted warranty cost and probability can be used in an actuarial pricing model to determine the extended warranty price.

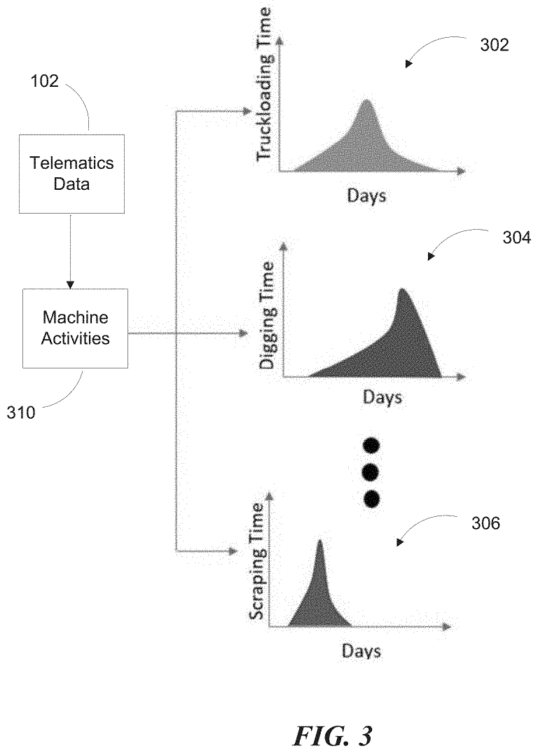

With reference to FIG. 3, the telematics data 102 can be analyzed by telematics processing system 106 to provide machine activity information 310. Given the machine activity information 310 for a machine, a distribution (i.e., histogram) can be created for each activity type for a corresponding warranty time period (e.g., one year). For example, distribution 302 represents the distribution of time (e.g., hours/day) that the machine spends loading trucks over the warranty time period. Distribution 304 represents the distribution of time that the machine spends digging and distribution 306 represents the distribution of time that the machine spends on scraping over the time period.

In the model training module 120 a machine learning model can be constructed that captures the dependence of warranty cost as a function of features derived from the machine activity distributions (e.g., distributions 302, 304, 306). The model uses information or features that can be derived from these historical machine utilization distributions, such as moment features (e.g., mean, standard deviation, skewness, kurtosis). For example, in some embodiments the mean of each distribution (e.g., distributions 302, 304, 306) can be the selected moment feature.

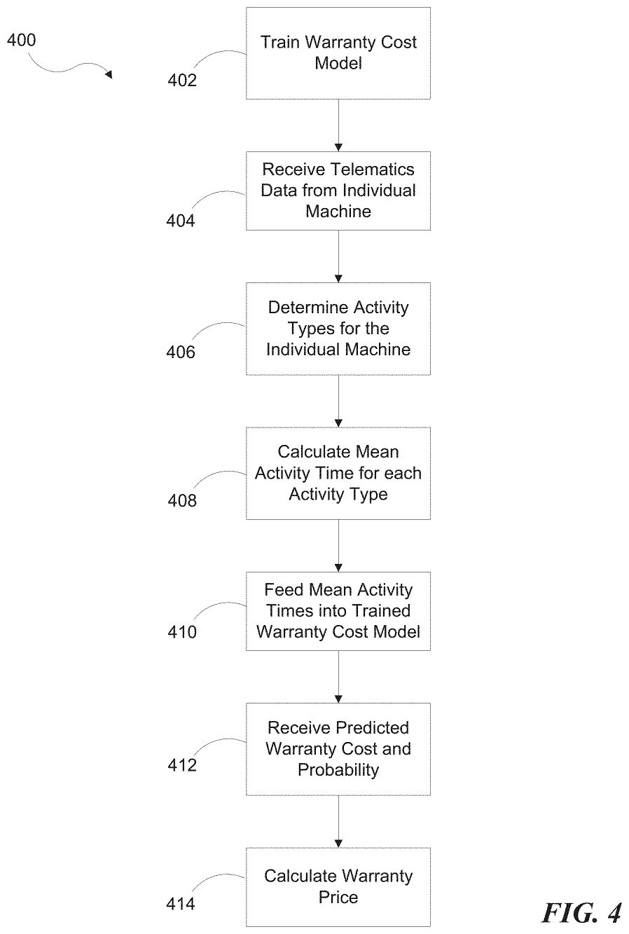

FIG. 4 is a flow diagram showing a method 400 for estimating warranty costs for an individual machine and providing extended warranty pricing according to some embodiments of the disclosed technology. The method 400 can include training a warranty cost model, such as a neural network, at step 402. The method 400 can also include receiving telematics data from a plurality of sensors on an individual machine at step 404 and determining one or more activity types for the individual machine based on the associated telematics data at step 406. In some embodiments, the method 400 can include a step to determine if the machine is an outlier (i.e., telematics data suggests an unknown application) in which case the process stops in order to prevent providing erroneous pricing. A moment feature, e.g., mean activity time, can be calculated for each activity type based on the collected activity data at step 408. The mean activity time for each activity type can be fed into the trained warranty cost model at step 410 to provide a predicted warranty cost for the individual machine and a corresponding probability of the predicted warranty cost from the trained warranty cost model at step 412. The method 400 can further comprise calculating an extended warranty price based on the predicted warranty cost and the corresponding probability at step 414.

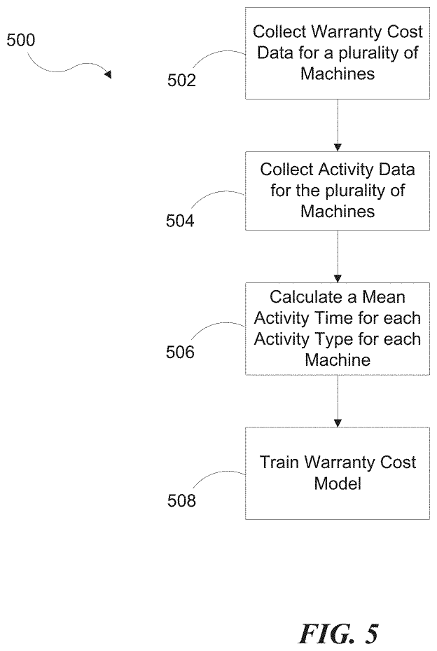

FIG. 5 is a flow diagram showing a method 500 for training a warranty cost model according to some embodiments of the disclosed technology. The method 500 can include collecting, at step 502, warranty cost data for a plurality of machines over a warranty time period (e.g., one year), and collecting, at step 504, activity data for a plurality of activity types over the warranty time period for each of the plurality of machines. Training the model can also include calculating a mean activity time for each activity type for each of the plurality of machines based on the collected activity data at step 506, and training the warranty cost model using the mean activity time for each activity type and the corresponding warranty cost data for each of the plurality of machines at step 508. In some embodiments, collecting the activity data at 504 can comprise receiving telematics data from a plurality of sensors on each of the plurality of machines and determining one or more activity types for each machine based on the associated telematics data.

### Suitable System

The techniques disclosed here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

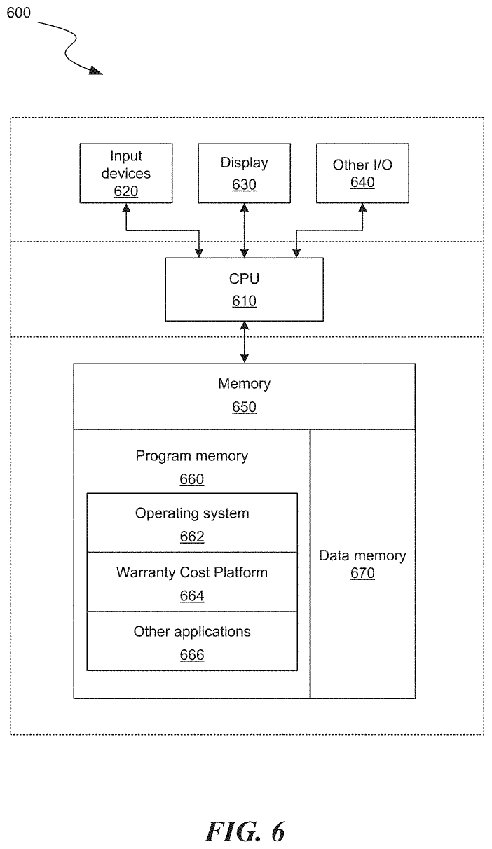

Several implementations are discussed below in more detail in reference to the figures. FIG. 6 is a block diagram illustrating an overview of devices on which some implementations of the disclosed technology can operate. The devices can comprise hardware components of a device 600 that performs warranty cost prediction and pricing, for example. Device 600 can include one or more input devices 620 that provide input to the CPU (processor) 610, notifying it of actions. The actions are typically mediated by a hardware controller that interprets the signals received from the input device and communicates the information to the CPU 610 using a communication protocol. Input devices 620 include, for example, sensors, a mouse, a keyboard, a touchscreen, an infrared sensor, a touchpad, a wearable input device, a camera- or image-based input device, a microphone, or other user input devices.

CPU 610 can be a single processing unit or multiple processing units in a device or distributed across multiple devices. CPU 610 can be coupled to other hardware devices, for example, with the use of a bus, such as a PCI bus or SCSI bus. The CPU 610 can communicate with a hardware controller for devices, such as for a display 630. Display 630 can be used to display text and graphics. In some examples, display 630 provides graphical and textual visual feedback to a user. In some implementations, display 630 includes the input device as part of the display, such as when the input device is a touchscreen or is equipped with an eye direction monitoring system. In some implementations, the display is separate from the input device. Examples of display devices are: an LCD display screen; an LED display screen; a projected, holographic, or augmented reality display (such as a heads-up display device or a head-mounted device); and so on. Other I/O devices 640 can also be coupled to the processor, such as a network card, video card, audio card, USB, FireWire or other external device, sensor, camera, printer, speakers, CD-ROM drive, DVD drive, disk drive, or Blu-Ray device.

In some implementations, the device 600 also includes a communication device capable of communicating wirelessly or wire-based with a network node. The communication device can communicate with another device or a server through a network using, for example, TCP/IP protocols. Device 600 can utilize the communication device to distribute operations across multiple network devices.

The CPU 610 can have access to a memory 650. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 650 can include program memory 660 that stores programs and software, such as an operating system 662, Warranty Cost Platform 664, and other application programs 666. Memory 650 can also include data memory 670 that can include database information, etc., which can be provided to the program memory 660 or any element of the device 600.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, programmable consumer electronics, network PCs, minicomputers, mainframe computers, distributed computing environments that include any of the above systems or devices, or the like.

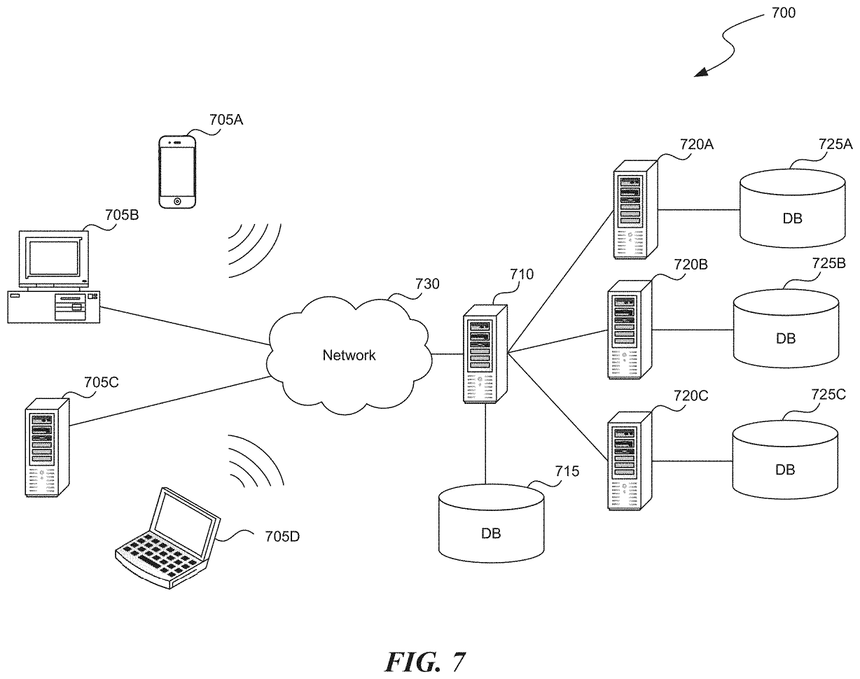

FIG. 7 is a block diagram illustrating an overview of an environment 700 in which some implementations of the disclosed technology can operate. Environment 700 can include one or more client computing devices 705A-D, examples of which can include device 600. Client computing devices 705 can operate in a networked environment using logical connections through network 730 to one or more remote computers, such as a server computing device 710.

In some implementations, server computing device 710 can be an edge server that receives client requests and coordinates fulfillment of those requests through other servers, such as servers 720A-C. Server computing devices 710 and 720 can comprise computing systems, such as device 600. Though each server computing device 710 and 720 is displayed logically as a single server, server computing devices can each be a distributed computing environment encompassing multiple computing devices located at the same or at geographically disparate physical locations. In some implementations, each server computing device 720 corresponds to a group of servers.

Client computing devices 705 and server computing devices 710 and 720 can each act as a server or client to other server/client devices. Server 710 can connect to a database 715. Servers 720A-C can each connect to a corresponding database 725A-C. As discussed above, each server 720 can correspond to a group of servers, and each of these servers can share a database or can have their own database. Databases 715 and 725 can warehouse (e.g., store) information. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN), but can also be other wired or wireless networks. Network 730 may be the Internet or some other public or private network. Client computing devices 705 can be connected to network 730 through a network interface, such as by wired or wireless communication. While the connections between server 710 and servers 720 are shown as separate connections, these connections can be any kind of local, wide area, wired, or wireless network, including network 730 or a separate public or private network.

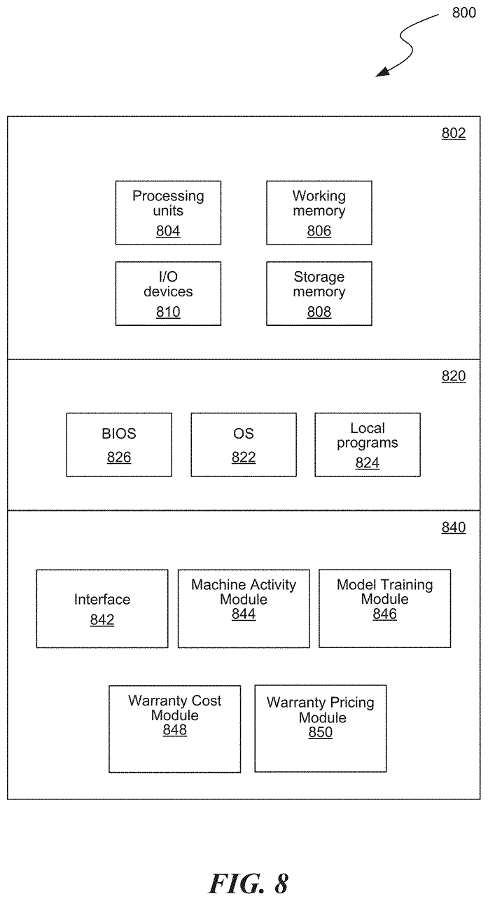

FIG. 8 is a block diagram illustrating components 800 which, in some implementations, can be used in a system employing the disclosed technology. The components 800 include hardware 802, general software 820, and specialized components 840. As discussed above, a system implementing the disclosed technology can use various hardware, including processing units 804 (e.g., CPUs, GPUs, APUs, etc.), working memory 806, storage memory 808, and input and output devices 810. Components 800 can be implemented in a client computing device such as client computing devices 705 or on a server computing device, such as server computing device 710 or 720.

General software 820 can include various applications, including an operating system 822, local programs 824, and a basic input output system (BIOS) 826. Specialized components 840 can be subcomponents of a general software application 820, such as local programs 824. Specialized components 840 can include a Machine Activity Module 844, a Model Training Module 846, a Warranty Cost Module 848, a Warranty Pricing Module 850, and components that can be used for transferring data and controlling the specialized components, such as Interface 842. In some implementations, components 800 can be in a computing system that is distributed across multiple computing devices or can be an interface to a server-based application executing one or more of specialized components 840.

Those skilled in the art will appreciate that the components illustrated in FIGS. 6-8 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described herein.

### INDUSTRIAL APPLICABILITY

In some embodiments, an extended warranty pricing system can include a machine activity module 844, a model training module 846, a warranty cost module 848, and a warranty pricing module 850 (FIG. 8). In operation, the machine activity module 844 can receive telematics data from one or more machines, such as excavators. The telematics data can include sensor data from the excavators, such as from pressure sensors, vibration sensors, and temperature sensors. The machine activity module 844 can determine a machine utilization pattern for the machines based on the telematics data. For example, a machine learning model can be applied to estimate each machine's utilization pattern based on the telematics data. The machine learning model can differentiate between, for example, mass excavation, dirt moving, trenching, scraping, grading, loading, tracking, or idle time. The resulting machine utilization patterns, or activity data, can be provided to the model training module 846 and the warranty cost module 848.

The model training module 846 can collect warranty cost data for a plurality of machines over a warranty time period (e.g., one year), and collecting activity data for a plurality of activity types over the warranty time period for each of the plurality of machines. The model training module 846 can also calculate a mean activity time for each activity type for each of the plurality of machines based on the collected activity data and train the warranty cost model using the mean activity time for each activity type and the corresponding warranty cost data for each of the plurality of machines.

The warranty cost module 848 can receive telematics data from a plurality of sensors on an individual machine and determining one or more activity types for the individual machine. In some embodiments, the warranty cost module 848 can receive the activity type information from the machine activity module 844. The warranty cost module 848 can calculate a moment feature, e.g., mean activity time, for each activity type based on the collected activity data. The mean activity time for each activity type can be fed into the trained warranty cost model to provide a predicted warranty cost for the individual machine and a corresponding probability of the predicted warranty cost from the trained warranty cost model.

The warranty pricing module 850 can calculate an extended warranty price based on the predicted warranty cost and the corresponding probability. For example, an extended warranty price can be calculated by dividing the predicted warranty cost by the probability and adding a fixed profit or a percentage profit. The prior art is not directed to extended warranty pricing based on a library of actual warranty costs compared to actual activity data for a large set of machines. The disclosed technology provides an advantage over know systems in that it can provide extended warranty pricing for a specific machine based on a detailed analysis of actual use (e.g., during at least a portion of the original warranty period), including activity type, over time as compared to market average costs.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A method for estimating warranty costs for an individual machine, comprising:
training a warranty cost model;
receiving telematics data from a plurality of sensors on an individual machine;
determining one or more activity types for the individual machine based on the associated telematics data;
calculating a mean activity time for each activity type;
feeding the mean activity time for each activity type into the trained warranty cost model; and
receiving a predicted warranty cost for the individual machine and a corresponding probability of the predicted warranty cost from the trained warranty cost model.

2. The method of claim 1, wherein training the warranty cost model comprises:
collecting warranty cost data for a plurality of machines over a warranty time period;
collecting activity data for a plurality of activity types over the warranty time period for each of the plurality of machines;
calculating a mean activity time for each activity type for each of the plurality of machines based on the collected activity data; and
training the warranty cost model using the mean activity time for each activity type and the corresponding warranty cost data for each of the plurality of machines.

3. The method of claim 2, wherein collecting the activity data comprises receiving telematics data from a plurality of sensors on each of the plurality of machines and determining one or more activity types for each machine based on the associated telematics data.

4. The method of claim 1, further comprising calculating a warranty price based on the predicted warranty cost and the corresponding probability.

5. The method of claim 4, wherein the warranty price is for an extended warranty.

6. The method of claim 1, wherein the warranty cost model comprises a neural network.

7. A system for estimating warranty costs for an individual machine, comprising:
one or more processors; and
one or more memory devices having stored thereon instructions that when executed by the one or more processors cause the one or more processors to:
train a warranty cost model;
receive telematics data from a plurality of sensors on an individual machine;
determine one or more activity types for the individual machine based on the associated telematics data;
calculate a mean activity time for each activity type;
feed the mean activity time for each activity type into the trained warranty cost model; and
receive a predicted warranty cost for the individual machine and a corresponding probability of the predicted warranty cost from the trained warranty cost model.

8. The system of claim 7, wherein training the warranty cost model comprises:
collecting warranty cost data for a plurality of machines over a warranty time period;
collecting activity data for a plurality of activity types over the warranty time period for each of the plurality of machines;
calculating a mean activity time for each activity type for each of the plurality of machines based on the collected activity data; and
training the warranty cost model using the mean activity time for each activity type and the corresponding warranty cost data for each of the plurality of machines.

9. The system of claim 8, wherein collecting the activity data comprises receiving telematics data from a plurality of sensors on each of the plurality of machines and determining one or more activity types for each machine based on the associated telematics data.

10. The system of claim 7, further comprising calculating a warranty price based on the predicted warranty cost and the corresponding probability.

11. The system of claim 10, wherein the warranty price is for an extended warranty.

12. The system of claim 7, wherein the warranty cost model comprises a neural network.

13. The system of claim 7, further comprising the plurality of sensors on the individual machine.

14. The system of claim 7, wherein the telematics data from the plurality of sensors is received via a satellite network.

15. One or more non-transitory computer-readable media storing computer-executable instructions that, when executed by one or more processors, cause the one or more processors to perform operations comprising:
training a warranty cost model;
receiving telematics data from a plurality of sensors on an individual machine;
determining one or more activity types for the individual machine based on the associated telematics data;
calculating a mean activity time for each activity type;
feeding the mean activity time for each activity type into the trained warranty cost model; and
receiving a predicted warranty cost for the individual machine and a corresponding probability of the predicted warranty cost from the trained warranty cost model.

16. The non-transitory computer-readable media of claim 15, wherein training the warranty cost model comprises:
collecting warranty cost data for a plurality of machines over a warranty time period;
collecting activity data for a plurality of activity types over the warranty time period for each of the plurality of machines;
calculating a mean activity time for each activity type for each of the plurality of machines based on the collected activity data; and
training the warranty cost model using the mean activity time for each activity type and the corresponding warranty cost data for each of the plurality of machines.

17. The non-transitory computer-readable media of 16, wherein collecting the activity data comprises receiving telematics data from a plurality of sensors on each of the plurality of machines and determining one or more activity types for each machine based on the associated telematics data.

18. The non-transitory computer-readable media of 15, further comprising calculating a warranty price based on the predicted warranty cost and the corresponding probability.

19. The non-transitory computer-readable media of 18, wherein the warranty price is for an extended warranty.

20. The non-transitory computer-readable media of 15, wherein the warranty cost model comprises a neural network.
